(19) United States
(12) Patent Application Publication
(10) Pub. No.: US 2011/0022423 A1
(43) Pub. Date: Jan. 27, 2011

(54) METHODS AND SYSTEMS FOR TRANSMITTING ALERTS ON HOTEL DEALS

(75) Inventor: Sam Shank, San Mateo, CA (US)

Correspondence Address: PERKINS COIE LLP, P.O. BOX 1208, SEATTLE, WA, 98111-1208, US

(73) Assignee: Dealbase, Inc., San Marcos, CA (US)

(21) Appl. No.: 12/510,116

(22) Filed: Jul. 27, 2009

(51) Int. Cl. G06Q 50/00; G06Q 30/00; G06F 17/30; G06F 15/16; G06Q 10/00

(52) U.S. Cl. 705/5; 705/14.39; 709/206; 707/E17.014; 707/E17.044; 707/E17.018; 705/26.41

(57) ABSTRACT

Disclosed herein are methods and systems for transmitting hotel deal alerts. In one embodiment, a deal alert service receives a request to periodically receive hotel related deals satisfying a specific criteria, such as being from one or more geographic locations. Based on a frequency of the periodic basis, the deal alert service generates a list of hotel deals and sends it to the user during each frequency cycle. The deal alert service transmits the list of hotel deals using a specific transmission mechanism indicated by the user. Additionally, each list item of the list of hotel-deals includes a hyperlink to a primary source offering the hotel and the saving-deal. Upon selecting a list item of the list of hotel-deals, the user is transported to an entity associated with the primary source, through which the user is able to complete a transaction to book a hotel room and receive the posted saving-deal.

### FIELD OF INVENTION

The present invention generally relates to the field of saving-deal alerts. More particularly, the present invention relates to methods and systems for transmitting alerts on hotel deals to users subscribing to a deal alert service.

### BACKGROUND OF THE INVENTION

Regardless of whether a person travels for work or for leisure, staying in a hotel is an indispensable component of the person's travel. Due to the availability of multiple hotels in any geographic location, hotels usually face stiff competition in luring weary travelers. Owing in part to such competition, and in part to building a loyal customer base, hotels offer saving-deals (or simply, deals) on different occasions to entice customers to stay with them. In some instances, travel agents or other contracting parties obtain a large contingent of hotel rooms from a hotel at a subsidized price, and offer the savings to their customers in return for their patronage. However, a person trying to book a room at a specific geographic location (e.g., in a particular city) may not be immediately aware of various deals offered by the various hotels in that particular geographic location.

In some instances, a user may use a travel-agent website (e.g., Expedia.com®) to identify a list of hotels in a particular geographic location. However, such websites are geared toward providing the user a list of various hotels available in that location, but not at the type of deals offered by the hotels in that location. Additionally, the travel-agent website merely provides an instant display of hotel availability in one or more geographic locations, but does not provide any mechanism for a user to monitor hotel and/or hotel-deal availability in a specific geographic location over a period of time. A user would have to login to a travel-agent website every time he desires to check for availability of hotels in a particular geographic location.

Overall, the examples herein of some prior or related systems and their associated limitations are intended to be illustrative and not exclusive. Other limitations of existing or prior systems will become apparent to those of skill in the art upon reading the following Detailed Description.

### SUMMARY OF THE DESCRIPTION

At least one embodiment of this invention pertains to a deal alert service. The deal alert service allows a user to specify one or more criteria (e.g., geographic locations) to track deals available on hotels in the specified geographic locations. In some instances, the deal alert service also allows the user to specify a list of preferences related to receiving the hotel-deal alerts. Examples of such preferences may include one or more of a frequency for periodic transmission of hotel deal alerts for a given geographic location, a transmission mechanism (e.g., email, voice mail, text message, etc.) for transmitting the hotel deal alerts, price range, savings range, minimum number of nights, dates, distance from a specified geographic location, hotel rating, hotel brand, keywords, specific hotel, hotel category (e.g., beachfront, downtown), weekends, weekdays, deal categories (e.g., breakfast included), etc.

The deal alert service, upon receiving the request from the user, queries one or more hotel-deal sources to generate a list of hotel deals for each specified geographic location or other selected criteria. In some instances, the hotel-deal source is a local database that stores information retrieved from one or more primary sources. In other instances, the hotel-deal source is an entity associated directly with one or more primary sources. Examples of primary sources include a web service associated with a hotel offering the saving-deal, a web service associated with a travel-agent offering the saving-deal, etc. The deal alert service then transmits the list of hotel deals to the user using the specified transmission mechanism.

One of the advantages of the deal alert service is that a user can receive alerts, on a periodic basis, on hotels located at a specific geographic location. The user does not have to conduct a search of hotels at a particular geographic location every time he wishes to inquire about hotel-deals in that particular location. Instead, the deal alert service personalizes the deal alerts and delivers them to the user (e.g., to the user's email address) on a recurring basis at a specific frequency chosen by the user (e.g., every day, every week, etc.).

In at least one embodiment, the user receives a list of hotel deals and alerts specific to a given location. Each of the items in the list of hotel deals includes a hyperlink to a primary source (e.g., the hotel website) offering the saving-deal. The user would then have to click the hyperlink to connect directly to the primary source to complete a transaction to book a hotel room at the specified deal price.

Consider an illustrative example, where a user wishes to take his family out to Disney World® in Orlando, Fla. The user has no strict schedule to adhere to, but wants to travel when one of the hotels in Orlando offers a good saving-deal. So, the user wishes to check, on a weekly basis, the availability of saving-deals for hotels in the Orlando area. Using previously available methods, the user would have had to login to a travel agent website (e.g., Expedia.com®), or directly to hotel websites (e.g., HawthornSuites.com®, EmbassySuites.com®, etc.) to monitor the availability of saving-deals for hotels in the Orlando area. Also, using previously available methods, the user would have had to manually perform the search on each website every week to monitor the hotel prices and the availability of saving-deals. However, using the deal alert service, the user would just have to provide his preferences just once. For example, the user would provide the following input to the deal alert service: search for deals on hotels in Orlando, Fla.; provide a weekly report every Sunday; send the weekly report to a particular email address. Subsequently, the deal alert service would send a weekly email (i.e., every Sunday) with a list of saving-deal alerts available in the Orlando, Fla. area. As will be appreciated, the deal alert can be distributed on a Tuesday or any day, which may be user or system defined. The user can simply peruse the list and decide to proceed further when he spots an interesting saving-deal. When he spots an interesting deal, the user would merely have to click on a hyperlink included in the list. Upon clicking on the hyperlink, the user is transported directly to the hotel's website (or the travel agent's website), where he can complete booking the room and take advantage of the saving-deal.

Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 and the following discussion provide a brief, general description of a representative environment in which the invention can be implemented;

FIG. 2 is a block diagram illustrating an exemplary architecture of a deals server configured to perform the various functionalities of the deal alert service;

FIG. 3 depicts an exemplary webpage through which the user can gain access to the deal alert service;

FIG. 4 illustrates a representation of a personalized alert sent to a user;

FIG. 5 is a flow diagram depicting a process for transmitting a personalized hotel alert to a user; and

FIG. 6 is a high-level block diagram showing an example of the architecture for a computer system.

The headings provided herein are for convenience only and do not necessarily affect the scope or meaning of the claimed invention.

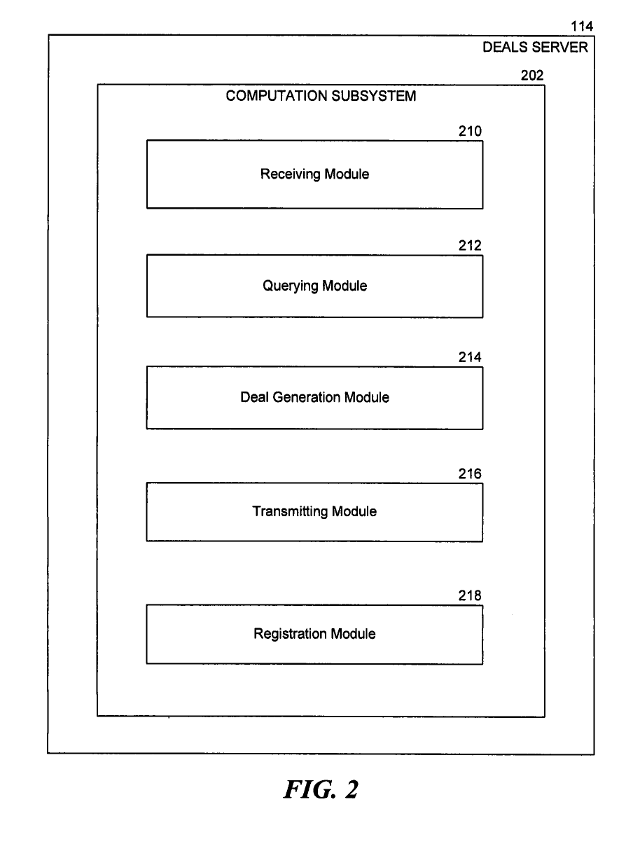

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

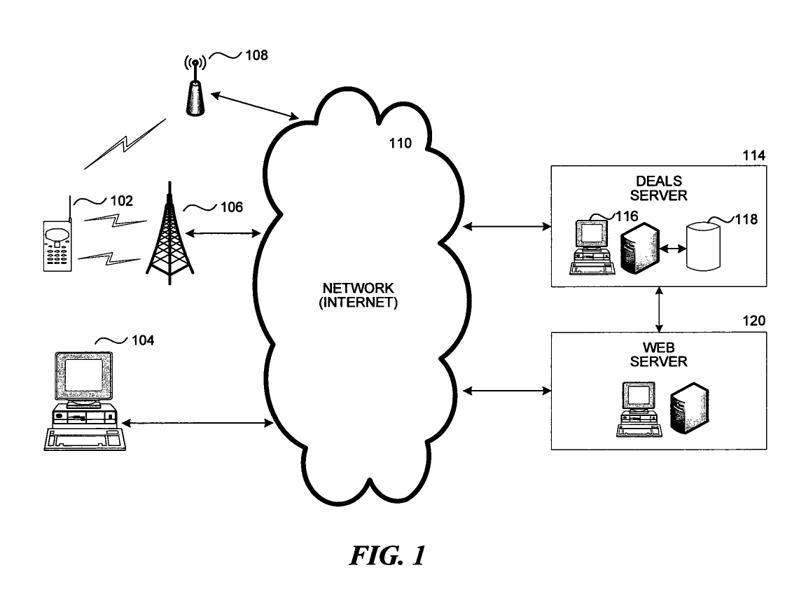

FIG. 1 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a phone 102, a personal computer 104, etc.) to communicate with a network. The term “phone,” as used herein, may be a cell phone, a personal digital assistant (PDA), a portable email device (e.g., a Blackberry®), a portable media player (e.g., an IPod Touch®), or any other device having communication capability to connect to the network. In one example, the phone 102 connects using one or more cellular transceivers or base station antennas 106 (in cellular implementations), access points, terminal adapters, routers or modems 108 (in IP-based telecommunications implementations), or combinations of the foregoing (in converged network embodiments).

In some instances, the network 110 is the Internet, allowing the phone 102 (with, for example, WiFi capability) or the personal computer 104 to access web content offered through various web servers. In some instances, especially where the phone 102 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, a user uses one of the personal computing devices (e.g., the phone 102, the personal computer 104, etc.) to connect to a deals server 114 through the network 110. In one embodiment, the deals server 114 comprises a server computer 116 coupled to a local database 118. The term “deals server” as indicated herein, refers to a server station or other computing apparatus capable of hosting a web service that is accessible by other computing systems (e.g., the personal computer 104) through, for example, the Internet.

The deals server 114 illustrated in FIG. 1 operates a hotel-deal alert service. The term “hotel-deal alert service” (or simply, a “deal alert service”) as indicated herein, refers to a suite of operations that may include, for example, querying multiple sources to identify hotel-deals in specific geographic locations, receiving requests from a user for hotel-deal alerts, creating a registered account for the user to record the user's preferences associated with receiving such alerts, generating and transmitting the alerts to the user on a periodic basis, etc. As will be explained in further detail herein, the deals server 114 incorporates one or more functional units to achieve each of the above discussed functionalities.

In some instances, the deals server 114 also operates as a web server to enable the deals alert service to be offered through a webpage. In such instances, the deals server 114 may operate additionally as a web server or may be coupled to a separate web server to provide the web functionalities.

As shown in FIG. 1, the personal computing devices and the deals server 114 are connected through the network 110 to one or more web servers (e.g., web server 120). Each web server corresponds to a computing station that enables a third party (e.g., a hotel website through which a user can book hotel rooms, a website hosted by a travel agent through which a user can book hotel rooms, etc.) to host, for example, a hotel-booking service that can be accessed through the network 110.

As will be explained in more detail below, in one embodiment, the deals server 114 (or specifically, the deal alert service running on the server computer 116) queries one or more web servers to retrieve information related to saving-deals associated with hotels in a particular geographic location. In some instances, the deal alert service may use search algorithms to first identify hotels located in a geographic location, and then search websites corresponding to the hotels to retrieve saving-deal information or other deals posted by the hotel. In such an instance, the deal alert service may use a third-party service to identify a list of hotels in a geographic location, and use one or more other third-party services to access the booking service and saving-deal information available for such hotels. Alternatively, or additionally, in some instances, the deal alert service may directly communicate with one or more primary sources to query hotels available in a particular location and retrieve saving-deal information and hotel-booking information through the primary sources.

One example of a primary source is an entity associated with a hotel chain. The entity could be a web server or a database or a website hosted by the hotel chain. In such an example, the deal alert service queries the entity associated with the hotel chain to retrieve information related to saving-deals and booking information for rooms in a hotel in one or more specific geographic locations. Another example of a primary source is an entity (e.g., web sever, a database, an application interface, a website operated by the primary source, etc.) associated with a travel agent (e.g., Expedia.com®, Hotwire.com®, etc.). The travel agent may have booking and saving-deal related information for one or more hotels at specific geographic locations. In such an example, the deal alert service queries the entity associated with the travel agent to retrieve information related to saving-deals and booking information for rooms in a hotel in one or more specific geographic locations. Other examples of primary sources, as understood by one of ordinary skill in the art, are also equally effective for use in conjunction with the deal alert service.

In one embodiment, the deal alert service queries the various primary sources for saving-deal and hotel booking related information, and causes the computing server 116 to save the information to the local database 118 of the deals server 114. The deal alert service may then utilize the information stored in the local database 118 when it has to generate a personalized alert to send to the user. Alternatively, or in addition, the deal alert service may simply query the third party services (e.g., through the web server 120) when it has to generate a personalized alert to send to the user, and transmit the information directly over to the user.

For purpose of further illustration, it is useful to consider the techniques explained herein as it applies to saving-deal alerts for hotels in one or more geographic locations. Of course, however, it should be noted that the techniques introduced here extend to other travel related deal-alerts, including, for example, transportation (e.g., rail, air, ship, etc.) saving-deals to/from a particular location, saving-deals for tourist activities (e.g., scuba diving, city tours, museum tickets, etc.) at a particular location, saving-deals for social activities (e.g., concert tickets, game tickets, etc.) at a particular location, and other such travel related events. In further embodiments, the deal alerts can specifically call out vacation packages such as air/car, air/car/hotel, and air/ship/hotel combinations.

FIG. 2 is a block diagram illustrating an exemplary architecture of a deals server 114 configured to perform the various functionalities of the deal alert service. In the illustrated embodiment, the deals server 114 includes a computation subsystem 202, which performs various functions related to the deal alert service. The computation subsystem 202 can be implemented by using programmable circuitry programmed by software and/or firmware, or by using special-purpose hardwired circuitry, or by using a combination of such embodiments. In some instances, the computation subsystem 202 is implemented as a unit in a processor of the deals server.

The computation subsystem 202 includes a receiving module 210 that, in some instances, is configured to communicate with external interfaces to receive a user input from the user. In one example, the user uses a personal computing device to open a website offering the deal alert service. The web server operating the deal alert service receives any requests sent by the user (e.g., selection of one or more geographic locations, selection of a transmission mechanism to send the messages, etc.) and transmits it to the receiving module 210 of the deals server 114. The receiving module, in some instances, receives the user's requests and processes the requests for further processing by the deals server 114.

The computation system 202 also includes a querying module. Consider the example where the receiving module 210 receives a request from the user to provide alerts related to hotel deals available in a first geographic location. The user, in some instances, may also request that the alerts be sent on a periodic basis (e.g., every hour, every day, every week, etc.), and that it be sent using a specific transmission mechanism (e.g., a text message to the user's mobile device, an email to the user's email account, a voice message to the user's phone, a display on a webpage, an intimation through a social networking website, etc.). Based on the request received by the receiving module 202, the querying module 210 queries one or more hotel-deal sources to identify the requested information.

In some instances, the hotel-deal source is the local database 118 associated with the deals server 114. As indicated above, the local database may, on its own frequency, periodically collect and update saving-deal information associated with various hotels at different geographic locations. As indicated above, the local database may receive such information directly from one or more primary sources. In such instances, the querying module 212 simply queries the local database 118 at each periodic instance of the periodic basis (as specified by the user) to identify and retrieve saving-deal information associated with one or more geographic locations. In some instances, as explained above, the hotel-deal source is an entity associated with the primary source. In such instances, the querying module 212 queries the entity associated with the primary source (e.g., a website operated by a hotel, a website operated by a travel agent, etc.) to receive saving-deal information related to hotels in one or more geographic locations.

The computation subsystem 202 includes a deal generation module 214 that is configured to generate personalized alerts for the user based on the preferences supplied by the user. The deal generation module 214 works in conjunction with the querying module 212 to identify the various saving-deals available for a particular geographic location. Again, based on the periodic basis set by the user, the deal generation module generates a list of deals to be sent to the user. In some instances, the deal generation module 214 generates a separate alert for each geographic location indicated by the user. In some instances, the deal generation module 214 generates a combined alert for all geographic locations indicated by the user. The deal generation module 214 also works in association with the transmitting module 216 to generate alerts based on the specific transmission mechanism chosen by the user. For example, the deal generation module 214 may generate an html based message when the alert is to be sent out as an email, and may instead generate a pure text message when the alert is to be sent out as a mobile text-message.

The computation subsystem 202, in some instances, may also include a transmitting module 216 configured to send out the personalized alerts to the users. The transmitting module 216 communicates with the receiving module 210 to determine the frequency at which the personalized alert is to be sent out. The transmitting module 216 also communicates with the deal generation module 214 to receive the one or more alerts to be sent out at the periodic instance of the periodic basis indicated by the user. In some instances, the transmitting module 216 also determines a protocol or other communication requirement (e.g., adding message headers, etc.) to transmit the message, based on the transmission mechanism specified by the user. In one example, the transmitting module 216 adds suitable message headers and transmits the personalized alert via an email server when the personalized alert is to be sent out as an email message.

The computation subsystem 202, in some instances, also includes a registration module 218 configured to manage the user's personalized registration account. In some instances, when the user requests personalized alerts, the deals server 114, using the registration module 218, establishes a personalized registration account for the user. The registration module 218 stores the user's preferences in association with this personalized account. Examples of such preferences include: the geographic locations for which deal alerts need to be sent out, the transmission mechanism for each geographic location, etc. Additional examples of such preferences are explained in detail further below. The registration module 218, in some instances, stores the preferences and other registration information in the local database 118.

The registration module 218, in some instances, is also responsible for maintaining user-provided feedback or other information related to the deal alert service. In one example, the user, subsequent to a stay in a hotel identified through the deal-alert service, may provide feedback (e.g., in the form of a star rating) about the hotel, room service, the ease of using the primary source associated with the hotel, or other such experiences through the website operated by the deal alert service. In such instances, the registration module 218 stores the feedback information provided by the user in conjunction with the user's personalized account.

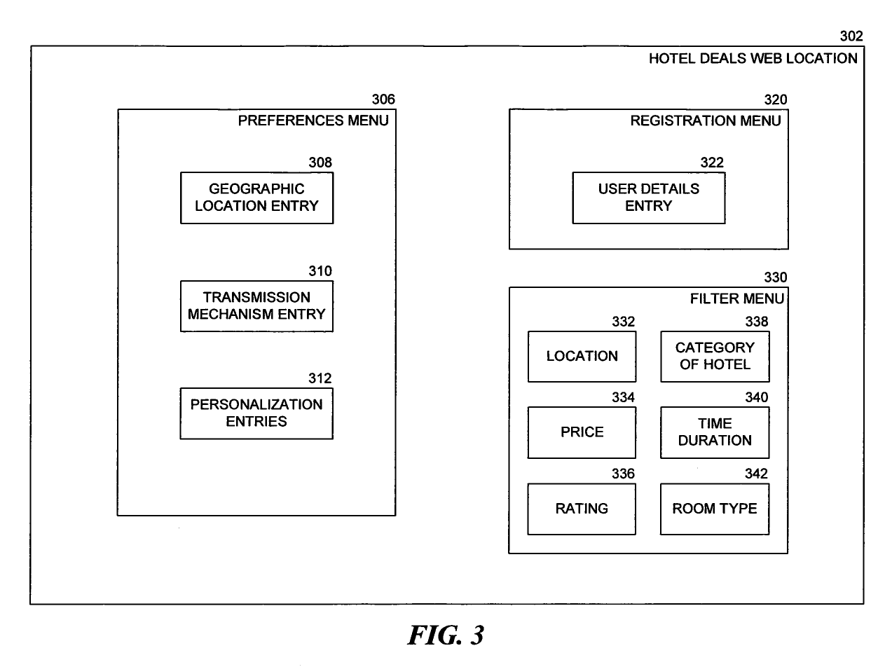

FIG. 3 depicts an exemplary webpage 302 through which the user can gain access to the deal alert service. The webpage 302 includes a preferences menu 306 through which the user can indicate one or more preferences for receiving saving-deal alerts. In some instances, the preferences menu 306 includes a geographic location entry block 308, through which the user can indicate one or more geographic locations. In some instances, as indicated above, the deal alert service saves the user's selections in a registration account, such that the geographic locations previously selected by the user are displayed (not shown in FIG. 3) for the user's benefit. Additionally, the preferences menu 306 may include a transmission mechanism entry block 310. Using this block, the user can indicate a preference on the transmission mechanism that is to be used (e.g., email, voicemail, etc.) to send out the saving-deal alerts. In some instances, the preferences menu 306 allows the user to select a separate transmission mechanism for each individual geographic location selected by the user.

In addition to the above blocks, the preferences menu 306 may also include a variety of other personalization entry options 312. Examples of such personalization entries include a frequency (of the periodic basis) for receiving the personalized alerts. In some instances, the preferences menu 306 provides the user the option to choose a separate frequency value for each selected geographic location (e.g., weekly alerts for San Francisco, Calif. saving-deals, monthly alerts for Folsom, Calif. saving-deals, etc.). Other personalization entries include, for example: favorite hotels associated with a given geographic location; hotels to be avoided in a given geographic location; a desired category of a hotel in a given geographic location; a desired price range for the hotel; a desired rating for the hotel; a desired time duration for booking the hotel; a keyword associated with the given geographic location; a desired type of room; a desired tag for selecting the hotel; etc.

In some instances, the webpage 302 may include a registration menu 320 to allow a user to enter personalization details to establish (or login to) a personalized registration account. The deal alerts server uses details (e.g., user name, password, user's email address, etc.) entered by the user through a user details entry block 322 to establish the personalized registration account.

In some instances, the webpage 302 includes a filter menu 330 to provide the user with a set of choices aimed at personalizing the content of the personalized alerts sent to the user. In one example, the user can use a location block 332 to indicate which locations are to be listed first, or if all locations are to be listed together, or whether the locations should be listed by state, etc. In another example, the user can use the category block 338 to indicate a certain category of hotels to be listed (e.g., beach-side hotels, casinos, spa resorts, etc.). In another example, the user can use the price block 334 to filter the personalized alert list based on a price limit or a price range. In another example, the user can filter the results based on a particular rating of the hotels (e.g., only hotels with a rating of 4-star or above). In another example, the user can use a room-type block 342 to filter results based on a particular room-type availability (e.g., penthouse suites, non-smoking rooms, rooms with two queen beds, etc.). Other examples include: a keyword or tag associated with the hotel (e.g., Disneyland® hotels); a desired time duration or occasion for the hotel availability (e.g., weekend availability, rooms rented on a monthly basis, etc.).

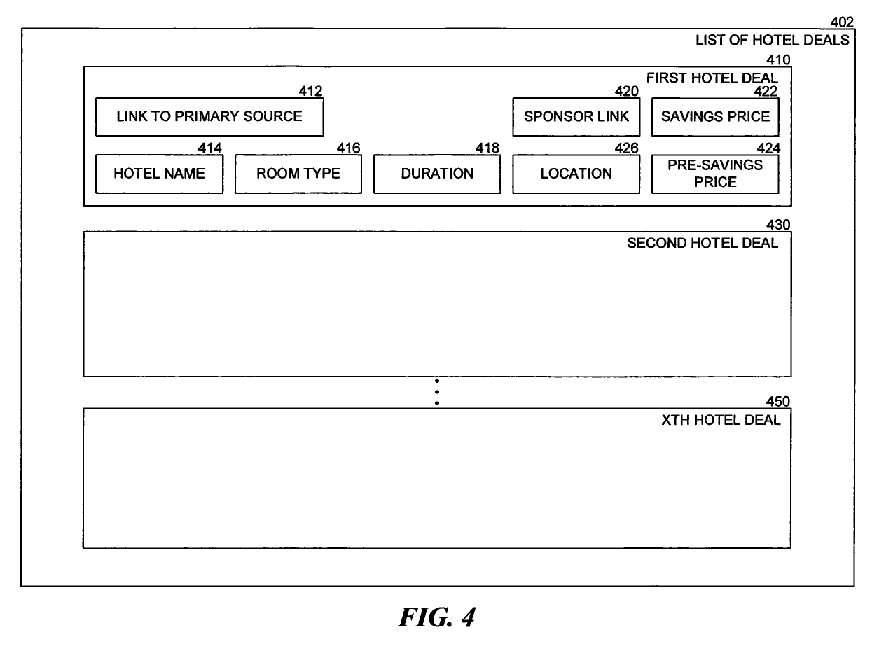

FIG. 4 illustrates a representation of a personalized alert 402 sent to a user. In the embodiment illustrated in FIG. 4, the personalized alert 402 is transmitted as an html email that contains a list of hotel deals. As indicated above, the list of hotel deals may also be sent to the user in the form of a text message or a webpage. In some instances, the personalized alert 402 includes one or more blocks (e.g., 410, 420, 430, 450, etc.), each block corresponding to a saving-deal alert for a particular hotel in a given geographic location.

Each saving-deal alert includes a variety of details. In a first instance, the first hotel deal 410 includes a link to the primary source 412. It is noted that in at least one embodiment, the deal alert service searches primary sources and provides links to the primary sources. In such an embodiment, the user completes a transaction to book the hotel and receive the discount by using a service offered by the primary source. The user would use the link to the primary source 412 to establish connection with a service offered by the primary source (e.g., a website through which a room can be booked).

In addition to the link to the primary source 412, the personalized alert 402 may also include, for example, a hotel name 414, a type of room 416 offered for the displayed saving-deal price, a time duration 418 or period of availability for the displayed saving-deal price, the geographic location 426 of the hotel, a pre-savings price 424 and a post-savings price 422 for booking the hotel, one or more sponsor links 420 for activities or events related to the geographic location and/or the hotel (e.g., a discount for a luau dinner offered at the hotel, a discount for a snorkeling trip at the geographic location, etc.)., etc.

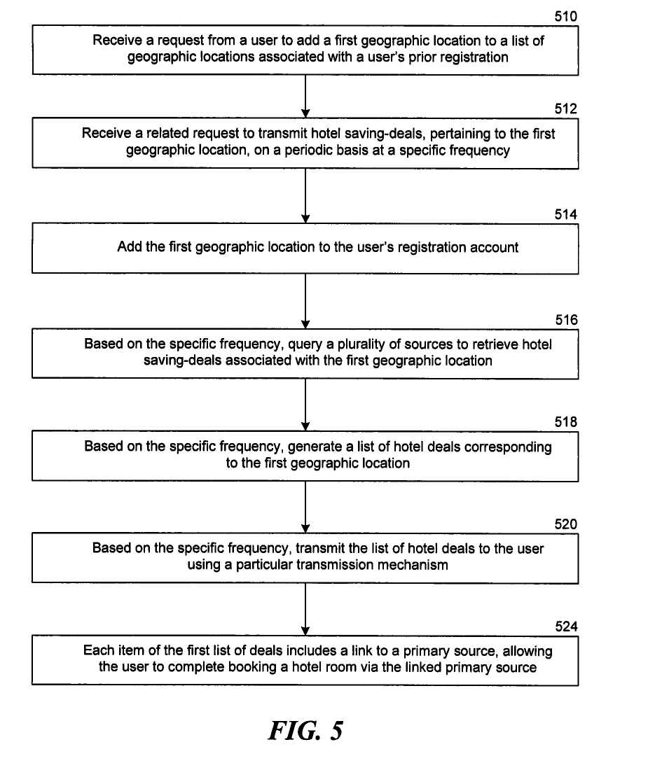

FIG. 5 is a flow diagram depicting a process for transmitting a personalized hotel alert to a user. As indicated in block 510, a deal alert service receives a request from a user to add a first geographic location to a list of geographic locations associated with a user's prior registration. If however the user does not have a prior registration, the deal alert service provides the user the option of registering for a personalized account. In either scenario, the deal alert service saves one or more geographic locations selected by the user in association with the user's registration account.

At block 512, the deal alert service receives further personalization-preferences from the user for receiving the personalized alert. In one example, the personalization-preference includes a preference for a frequency at which the personalized alert is to be sent to the user. In another example, the personalization-preference includes a preference for a transmission mechanism through which the personalized alert is to be sent out. Similarly, the personalization-preferences also include any of the other preferences indicated above with reference to FIG. 3.

At block 514, the deal alert service adds the geographic location(s) and the personalization preferences entered by the user to the user's registration account. Subsequently, as indicated in block 516, at each periodic instance, the deal alert service queries one or more hotel-deal sources to retrieve hotel saving-deals for hotels located in the one or more geographic locations specified by the user. As indicated above, in some instances, the hotel-deal source is the local database associated with the deals server. In other instances, the hotel-deal source includes one or more primary sources offering the respective saving-deal.

As indicated in block 518, subsequent to querying the hotel-deal sources, the deal alert service generates a list of hotel deals pertaining to the one or more geographic locations. The generated list of hotel deals is then transmitted to the user using a user-specific transmission mechanism, as indicated in block 520. As indicated in block 524, in at least one embodiment, each list-item of the list of hotel deals includes a link to a corresponding primary source, and the user has to follow the hyperlink to be able to complete the hotel reservation and receive the listed saving-deal. In such an embodiment, the user only receives a list of hotel deals through the deal alert service, and has to use a service offered by a corresponding primary source to book a hotel and a saving-deal offered by that primary source.

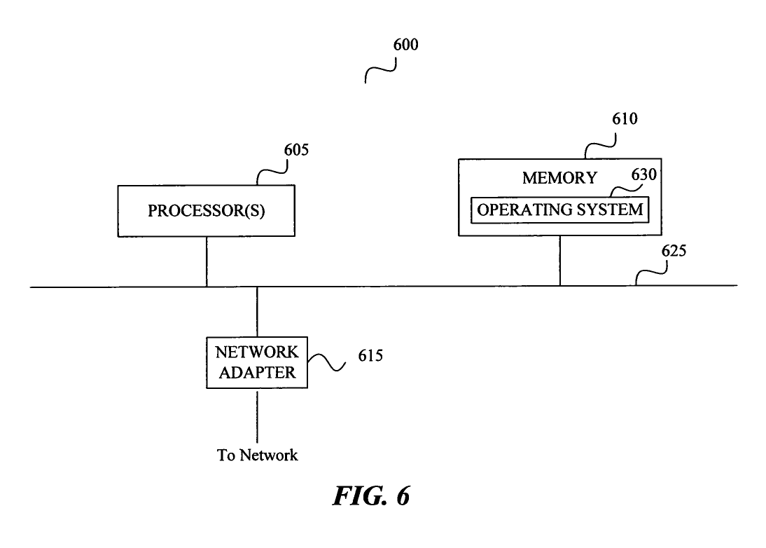

FIG. 6 is a high-level block diagram showing an example of the architecture for a computer system 600 that can be utilized to implement a deals server (e.g., 114 from FIG. 1), a web server (e.g., 125 from FIG. 1), etc. In FIG. 6, the computer system 600 includes one or more processors 605 and memory 610 connected via an interconnect 625. The interconnect 625 is an abstraction that represents any one or more separate physical buses, point to point connections, or both connected by appropriate bridges, adapters, or controllers. The interconnect 625, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Firewire”.

The processor(s) 605 may include central processing units (CPUs) to control the overall operation of, for example, the host computer. In certain embodiments, the processor(s) 605 accomplish this by executing software or firmware stored in memory 610. The processor(s) 605 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 610 is or includes the main memory of the computer system 1100. The memory 610 represents any form of random access memory (RAM), read-only memory (ROM), flash memory (as discussed above), or the like, or a combination of such devices. In use, the memory 610 may contain, among other things, a set of machine instructions which, when executed by processor 605, causes the processor 605 to perform operations to implement embodiments of the present invention.

Also connected to the processor(s) 605 through the interconnect 625 is a network adapter 615. The network adapter 615 provides the computer system 600 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

We claim:

1. A method for providing alerts related to hotel deals based on a specific criteria, the method comprising:
receiving a first request from a user to provide, on a periodic basis, alerts related to saving-deals available on one or more hotels satisfying the specific criteria; and
during each periodic instance of the periodic basis:
querying one or more hotel-deal sources to identify and collect information related to the saving-deals available on one or more hotels satisfying the specific criteria;
generating a first list of hotel deals pertaining to the specific criteria based on the query of the one or more hotel-deal sources; and
transmitting the first list of hotel deals to the user as a first personalized alert using a specific transmission mechanism.

2. The method of claim 1, wherein the specific criteria includes at least one of a given geographic location, a hotel category, a hotel rating, a range of dates, a specific hotel, a deal category, and a price range.

3. A method for providing alerts related to hotel deals in a given geographic location, the method comprising:
receiving a first request from a user to provide, on a periodic basis, alerts related to saving-deals available on one or more hotels located at a first geographic location; and
during each periodic instance of the periodic basis:
querying one or more hotel-deal sources to identify and collect information related to the saving-deals available on one or more hotels located at the first geographic location;
generating a first list of hotel deals pertaining to the first geographic location based on the query of the one or more hotel-deal sources; and
transmitting the first list of hotel deals to the user as a first personalized alert using a specific transmission mechanism.

4. The method of claim 3, wherein the specific transmission mechanism is specified by the user.

5. The method of claim 4, wherein the transmission mechanism includes one or more of:
transmitting the list of hotel deals as an electronic mail to an electronic mail account associated with the user;
transmitting the list of hotel deals as a text message to a mobile device associated with the user;
transmitting the list of hotel deals using an application of a social networking website;
transmitting the list of hotel deals as a voice message to a telecommunication device associated with the user; or
transmitting the list of hotel deals to a website for display of the list of hotel deals in a webpage.

6. The method of claim 3, wherein the one or more hotel-deal sources includes a local database, wherein the local database stores saving-deals retrieved from a plurality of primary sources, each of the plurality of primary sources corresponding to an entity through which the user can consummate a transaction to book a reservation and receive the saving-deal for a particular hotel in the first geographic location.

7. The method of claim 6, wherein each of the plurality of primary sources includes one or more of:
a website operated by a specific hotel through which the user can book a reservation to the specific hotel; or
a website operated by a travel agent advertising saving-deals for the specific hotel, wherein the user can book a reservation to the specific hotel through the website operated by the travel agent.

8. The method of claim 3, wherein the one or more hotel-deal sources includes a primary source, wherein the primary source corresponds to an entity through which the user can consummate a transaction to book a reservation and receive the saving-deal for a particular hotel in the first geographic location.

9. The method of claim 3, wherein each hotel deal of the first list of hotel deals includes a hyperlink to a primary source, wherein the primary source corresponds to an entity through which the user can consummate a transaction to book a reservation and receive the saving-deal for a particular hotel in the first geographic location.

10. The method of claim 8, wherein the primary source includes one or more of:
a website operated by a specific hotel through which the user can book a reservation to the specific hotel; or
a website operated by a travel agent advertising saving-deals for the specific hotel, wherein the user can book a reservation to the specific hotel through the website operated by the travel agent.

11. The method of claim 3, wherein each hotel deal displayed from the first list of hotel deals transmitted to the user includes one or more of:
a name of a specific hotel;
a rating information associated with the specific hotel;
a deal price for booking a room in the specific hotel;
information data related to the specific hotel and/or the room;
a deal price value for booking the room in the specific hotel;
savings information associated with booking the room in the specific hotel;
a hyperlink to a primary source, wherein the primary source corresponds to an entity through which the user can consummate a transaction to book a reservation and receive the saving-deal for a particular hotel in the first geographic location;
a duration through which the indicated deal price value is available; or
a sponsor link.

12. The method of claim 3, wherein the step of transmitting the first personalized alert based on the periodic basis includes one or more of:
transmitting the first personalized alert instantly;
transmitting the first personalized alert only once without any recurrence; or
transmitting the first personalized alert on a recurring basis based on a time frequency specified the user.

13. The method of claim 3, further comprising:
providing the user a mechanism to specify a plurality of preferences related to receiving and/or filtering the first personalized alert, the plurality of preferences including:
a frequency of receiving the first personalized alert;
favorite hotels associated with a given geographic location;
hotels to be avoided in the given geographic location;
a desired category of a hotel in the given geographic location;
a desired price range for the hotel;
a desired rating for the hotel;
a desired time duration for booking the hotel;
a keyword associated with the given geographic location;
a desired type of room; or
a desired tag for selecting the hotel.

14. The method of claim 3, further comprising:
subsequent to the user completing a booking of a specific hotel using the first list of hotel deals and/or completing a stay at the specific hotel, following up with the user to obtain user experience information, the user experience information including one or more of:
experience with using a primary source for booking the specific hotel;
experience of the user at the specific hotel; or
experience of the user at the first geographic location.

15. The method of claim 14, wherein the user posts the user experience information in the form of a star rating, further wherein the star rating is included in a subsequent display of the specific hotel and/or the primary source in a second list of hotel deals.

16. The method of claim 3, further comprising:
including additional travel related deals associated with the first geographic location, the additional travel related deals including one or more of:
deals related to air, ground and/or water transportation to the first geographic location;
sight-seeing and/or other tourist packages relevant to the first geographic location; or
social events related to the first geographic location.

17. The method of claim 3, further comprising:
setting up a personalized registered account for the user, wherein subsequent to setting up the registered account;
receiving a second request from the user to provide alerts related to saving-deals available on one or more hotels at a second geographic location, wherein the second geographic location is saved in association with the user's registered account.

18. The method of claim 17, further comprising:
subsequent to adding the second geographic location, sending a second list of travel deals as a second personalized alert to the user based on a second transmission mechanism selected by the user.

19. The method of claim 18, further comprising:
transmitting the first list of travel deals and the second list of travel deals to the user as a combined personalized alert using a specific transmission mechanism.

20. The method of claim 18, further comprising:
transmitting the first list of travel deals and the second list of travel deals as two discrete personalized alerts, each discrete personalized alert transmitted using an associated transmission mechanism.

21. The method of claim 18, further comprising:
transmitting the first list of travel deals according to the same periodic basis as that of the second list of travel deals.

22. The method of claim 18, further comprising:
transmitting the first list of travel deals and the second list of travel deals according to two discrete periodic bases.

23. A method for providing alerts related to hotel deals to a user, the method comprising:
providing a preferences menu to enable a user to select one or more geographic locations and a frequency at which the user would prefer to receive alerts related to saving-deals pertaining to the selected one or more geographic locations;
subsequent to the user providing an input using the preferences menu, generating, on a periodic basis as indicated by the selected frequency, a list of hotel deals pertaining to each of the selected one or more geographic locations, wherein each list item of the generated list of hotel deals includes a hyperlink to a web location of a corresponding primary source; and
transmitting, according to the periodic basis, the list of hotel deals to the user utilizing a specific transmission mechanism, wherein, upon the user selecting a first hyperlink from a first list item from the list of hotel deals, the user is transferred to a first web location of a first primary source corresponding to the first list item, enabling the user to consummate a transaction to book a reservation and receive the saving-deal for a first hotel associated with the first list item.

24. The method of claim 23, further comprising:
establishing a personalized registered account for the user, wherein the personalized registered account stores the user's preferences as indicated in the preferences menu.

25. The method of claim 24, wherein, the user can indicate additional preferences using the personalized registered account, the additional preferences including one or more of:
adding one or more additional geographic locations;
removing one or more geographic locations previously added to the user's personalized registered account;
the specific transmission mechanism to be used specifically for each individual geographic location;
the specific transmission mechanism to be used globally for all geographic locations;
favorite hotels associated with a given geographic location;
hotels to be avoided in the given geographic location;
a desired category of a given hotel;
a desired price range for the given hotel;
a desired rating for the given hotel;
a desired time duration for booking the given hotel;
a keyword associated with the given geographic location;
a desired type of room; or
a desired tag for selecting the given hotel.

26. The method of claim 23, further comprising:
generating a separate and individualized list of hotel deals for each of the one or more geographic locations.

27. The method of claim 23, further comprising:
generating a combined list of hotel deals that includes all of the one or more geographic locations.

28. The method of claim 23, wherein the first primary source is an entity that provides the saving-deal for the first hotel associated with the first list item, and wherein the user utilizes a service of the first primary source to consummate the transaction to book the reservation and receive the saving-deal for the first hotel associated with the first list item.

29. The method of claim 28, wherein the service of the first primary source is one or more of:
a website operated by the first hotel through which the user can book a reservation to the first hotel; or
a website operated by a travel agent advertising saving-deals for the first hotel, wherein the user can book a reservation to the first hotel through the website operated by the travel agent.

30. The method of claim 23, wherein, in addition to the first hyperlink to the first primary source, the first list item includes one or more of:
a name of the first hotel;
a rating information associated with the first hotel;
a deal price for booking a room in the first hotel;
information data related to the first hotel and/or the room;
a deal price value for booking the room in the first hotel;
savings information associated with booking the room in the first hotel;
a duration through which the indicated deal price value is available; or
a sponsor link.

31. A hotel-deal alerting system for providing alerts related to hotel deals to a user, the hotel-deal alerting system comprising:
a receiving module configured to receive a first request from a user to provide, on a periodic basis, alerts related to saving-deals available on one or more hotels located at a first geographic location;
a querying module configured to query, at each given periodic instance of the periodic basis, one or more hotel-deal sources to identify and collect information related to the saving-deals available on one or more hotels located at the first geographic location;
a deal-generation module configured to generate, at each given periodic instance, a first list of hotel deals pertaining to the first geographic location based on the query of the one or more hotel-deal sources; and
a transmitting module configured to transmit, at each given periodic instance, the first list of hotel deals to the user as a first personalized alert using a specific transmission mechanism.

32. The hotel-deal alerting system of claim 31, wherein the specific transmission mechanism is specified by the user, and wherein the specific transmission mechanism includes one or more of:
transmitting the list of hotel deals as an electronic mail to an electronic mail account associated with the user;
transmitting the list of hotel deals as a text message to a mobile device associated with the user;
transmitting the list of hotel deals using an application of a social networking website;
transmitting the list of hotel deals as a voice message to a telecommunication device associated with the user; or
transmitting the list of hotel deals to a website for display of the list of hotel deals in a webpage.

33. The hotel-deal alerting system of claim 31, wherein each of the one or more hotel-deal sources includes one or more of:
a local database, wherein the local database stores saving-deals retrieved from a plurality of primary sources, each of the plurality of primary sources corresponding to an entity through which the user can consummate a transaction to book a reservation and receive the saving-deal for a particular hotel in the first geographic location; or
one of the plurality of primary sources.

34. The hotel-deal alerting system of claim 33, wherein each of the plurality of primary sources includes one or more of:
a website operated by a specific hotel through which the user can book a reservation to the specific hotel; or
a website operated by a travel agent advertising saving-deals for the specific hotel, wherein the user can book a reservation to the specific hotel through the website operated by the travel agent.

35. The hotel-deal alerting system of claim 34, wherein the periodic basis includes one or more of:
transmitting the first personalized alert instantly;
transmitting the first personalized alert only once without any recurrence; or
transmitting the first personalized alert on a recurring basis based on a time frequency specified the user.

36. The hotel-deal alerting system of claim 31, further comprising:
a preference input module configured to provide the user a mechanism to specify a plurality of preferences related to receiving the first personalized alert, the plurality of preferences including:
a frequency of receiving the first personalized alert;
favorite hotels associated with a given geographic location;
hotels to be avoided in the given geographic location;
a desired category of a hotel in the given geographic location;
a desired price range for the hotel;
a desired rating for the hotel;
a desired time duration for booking the hotel;
a keyword associated with the given geographic location;
a desired type of room; or
a desired tag for selecting the hotel.

37. A hotel-deal alerting system for providing alerts related to hotel deals to a user, the hotel-deal alerting system comprising:
a processor;
a memory configured to store a set of instructions, which when executed by the processor cause the hotel-deal alerting system to perform a method, the method including:
providing a preferences menu to enable a user to select one or more geographic locations and a frequency at which the user would prefer to receive alerts related to saving-deals pertaining to the selected one or more geographic locations;
subsequent to the user providing an input using the preferences menu, generating, on a periodic basis as indicated by the selected frequency, a list of hotel deals pertaining to each of the selected one or more geographic locations, wherein each list item of the generated list of hotel deals includes a hyperlink to a web location of a corresponding primary source; and
transmitting, according to the periodic basis, the list of hotel deals to the user utilizing a specific transmission mechanism, wherein, upon the user selecting a first hyperlink from a first list item from the list of hotel deals, the user is transferred to a first web location of a first primary source corresponding to the first list item, enabling the user to consummate a transaction to book a reservation and receive the saving-deal for a first hotel associated with the first list item.

38. A hotel-deal alerting system for providing alerts related to hotel deals to a user, the hotel-deal alerting system comprising:
receiving means for receiving a first request from a user to provide, on a periodic basis, alerts related to saving-deals available on one or more hotels located at a first geographic location;
querying means for querying, at each given periodic instance of the periodic basis, one or more hotel-deal sources to identify and collect information related to the saving-deals available on one or more hotels located at the first geographic location;
deal-generation means for generating, at each given periodic instance, a first list of hotel deals pertaining to the first geographic location based on the query of the one or more hotel-deal sources; and
transmitting means for transmitting, at each given periodic instance, the first list of hotel deals to the user as a first personalized alert using a specific transmission mechanism.
